(19) United States
(12) Patent Application Publication
(10) Pub. No.: US 2020/0096953 A1
(43) Pub. Date: Mar. 26, 2020

(54) Automatic Compensation For An Electrical Device In An Electrical System

(71) Applicant: Eaton Intelligent Power Limited, Dublin 4 (IE)

(72) Inventors: Altan Stalker, Lawrenceville, GA (US); Russell Leake, Atlanta, GA (US); Nam Chin Cho, Peachtree City, GA (US)

(21) Appl. No.: 16/583,836

(22) Filed: Sep. 26, 2019

Related U.S. Application Data
(60) Provisional application No. 62/736,615, filed on Sep. 26, 2018.

(51) Int. Cl. G05B 9/03; G05B 23/02

(52) U.S. Cl. CPC G05B 9/03; H02G 3/121; G05B 23/0254

(57) ABSTRACT

A system can include multiple electrical devices that includes at least one sensor that measures a first parameter. The system can further include a controller communicably coupled to the electrical devices and the at least one sensor. The controller can receive a first measurement of a first parameter from at least one sensor, where the first measurement is associated with a first electrical device of the electrical devices; determine, based on the first measurement, that the first parameter falls outside a first range of acceptable values caused by a failure of the first electrical device; determine that adjusting at least one other electrical device compensates for the failure of the first electrical device; and adjust the at least one other electrical device from a default setting to a compensatory setting to compensate for the failure of the first electrical device.

### CROSS REFERENCE TO RELATED APPLICATIONS

This application claims priority under 35 U.S.C. § 119 to U.S. Provisional Patent Application Ser. No. 62/736,615, titled “Automatic Compensation For an Electrical Device In an Electrical System” and filed on Sep. 26, 2018, the entire contents of which are hereby incorporated herein by reference.

### TECHNICAL FIELD

The present disclosure relates generally to electrical systems, and more particularly to systems, methods, and devices for automatic compensation for electrical devices in electrical systems.

### BACKGROUND

A number of electrical systems, such as lighting systems, are designed to provide coverage for a broad area, and multiple devices of such an electrical system are used to provide adjacent coverages within the broad area. Sometimes, however, one of these electrical devices (or a portion thereof) fail to operate properly.

### SUMMARY

In general, in one aspect, the disclosure relates to a system that includes multiple electrical devices that form an electrical system, where the electrical devices perform a first function. The system can also include at least one sensor that measures a first parameter. The system can further include a controller communicably coupled to the electrical devices and the at least one sensor. The controller can receive a first measurement of the first parameter from the at least one sensor, where the first measurement is associated with a first electrical device. The controller can also determine, based on the first measurement, that the first parameter falls outside a first range of acceptable values for the first electrical device, where the first parameter falling outside the first range of acceptable values is caused by a failure of the first electrical device. The controller can further determine that adjusting at least one other electrical device compensates for the failure of the first electrical device. The controller can also adjust the at least one other electrical device from a default setting to a compensatory setting to compensate for the failure of the first electrical device.

In another aspect, the disclosure can generally relate to a controller for multiple electrical devices. The controller can include a memory for storing instructions and a hardware processor for executing the instructions. The controller can also include a control engine communicably coupled to the hardware processor. The control engine can be configured to receive a first measurement of a first parameter from at least one sensor, wherein the first measurement is associated with a first electrical device. The control engine can also be configured to determine, based on the first measurement, that the first parameter falls outside a first range of acceptable values for the first electrical device, where the first parameter falling outside the first range of acceptable values is caused by a failure of the first electrical device. The control engine can further be configured to determine that adjusting at least one other electrical device compensates for the failure of the first electrical device. The control engine can also be configured to adjust the at least one other electrical device from a default setting to a compensatory setting to compensate for the failure of the first electrical device.

In yet another aspect, the disclosure can generally relate to a non-transitory computer readable medium that includes computer readable program code embodied therein for performing a method of compensating for a failure of a first electrical device. The method can include receiving, by a controller, a first measurement of a first parameter from at least one sensor, where the first measurement is associated with the first electrical device. The method can also include determining, by the controller and based on the first measurement, that the first parameter falls outside a first range of acceptable values for the first electrical device, where the first parameter falling outside the first range of acceptable values is caused by a failure of the first electrical device. The method can further include determining, by the controller, that adjusting at least one other electrical device compensates for the failure of the first electrical device. The method can also include adjusting, by the controller, the at least one other electrical device from a default setting to a compensatory setting to compensate for the failure of the first electrical device.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 shows an office space within a building in which example embodiments can be used.

FIG. 2 shows a detail of part of the office space of FIG. 1.

FIG. 3 shows a system in accordance with certain example embodiments.

FIG. 4 shows a computing device in accordance with certain example embodiments.

FIG. 5 shows an electrical system in the current art with a number of electrical devices that are all operating properly.

FIG. 6 shows the electrical system of FIG. 5 where one of the electrical devices has failed.

FIG. 7 shows an electrical system with a number of electrical devices that are all operating properly in accordance with certain example embodiments.

FIG. 8 shows the electrical system of FIG. 7 where one of the electrical devices has failed.

FIG. 9 shows the electrical system of FIG. 8 where two of the electrical devices are adjusted to compensate for the failed electrical device.

### DETAILED DESCRIPTION

In general, example embodiments provide systems, methods, and devices for automatic compensation for electrical devices in electrical systems. Example embodiments can provide a number of benefits. Such benefits can include, but are not limited to, redundancy, increased reliability of the overall electrical system, effective energy management of light fixtures and other electrical devices in a space, improved safety, reduced operating costs, and compliance with industry standards (even during a failure) that apply to light fixtures and other electrical devices in certain environments.

Example embodiments are directed to automatically compensating for any of a number of different types of electrical devices. Examples of such electrical devices can include, but are not limited to, a light fixture (or, more generally, a luminaire), a wall outlet, a computer, a printer, a projector, a HVAC system (including, for example, a vent and a thermostat), a camera, a smoke detector, a security sensor, and a CO2 monitor.

Further, while example embodiments are described, by way of example herein, as being used in a building (e.g., an office space, a restaurant, a convention hall, a manufacturing facility), example embodiments can also be used in other areas where electrical devices can be located. Such other areas can include, but are not limited to, a parking structure, a parking lot, a street, a sidewalk, an outdoor stadium, and a park. Further, when applied to building environments, example embodiments can be used in any part of such building environments. Such parts of a building environment can include, but are not limited to, a small room (individual office, small conference room), a large room (large conference room), a break room, bathrooms, locker rooms, a corridor, a stairwell, an auditorium, a server room, an attic, a basement, a maintenance area, a manufacturing space, a shop floor, a storage room, an inventory space, and an arena.

When an electrical device is a light fixture, the light fixture can use any type of light source (e.g., light-emitting diode (LED), incandescent, sodium vapor, fluorescent). When light sources use LED technology, one or more of any type of LED technology can be included, such as chip-on-board, discrete, arrays, and multicolor. Further, the light fixture can be any type of light fixture, including but not limited to a troffer light fixture, a floodlight fixture, a street light fixture, a pendant light fixture, a hi-bay light fixture, a down can light fixture, a floor light fixture, a flood light fixture, a parking lot light fixture, a walkway light fixture, and an emergency egress light fixture.

In the foregoing figures showing example embodiments of automatic compensation for electrical devices in electrical systems, one or more of the components shown may be omitted, repeated, and/or substituted. Accordingly, example embodiments of automatic compensation for electrical devices in electrical systems should not be considered limited to the specific arrangements of components shown in any of the figures. For example, features shown in one or more figures or described with respect to one embodiment can be applied to another embodiment associated with a different figure or description.

In addition, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

In addition, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three-digit number, and corresponding components in other figures have the identical last two digits.

In certain example embodiments, light fixtures and/or other electrical devices that are automatically compensated for herein are subject to meeting certain standards and/or requirements. For example, the National Electric Code (NEC), the National Electrical Manufacturers Association (NEMA), the International Electrotechnical Commission (IEC), the Federal Communication Commission (FCC), the Illuminating Engineering Society (IES), and the Institute of Electrical and Electronics Engineers (IEEE) set standards as to electrical enclosures, wiring, and electrical connections. Use of example embodiments described herein meet (and/or allow a corresponding device to meet) such standards when required. In some (e.g., PV solar) applications, additional standards particular to that application may be met by the enclosures of electrical devices described herein.

Example embodiments of automatic compensation for electrical devices in electrical systems will be described more fully hereinafter with reference to the accompanying drawings, in which example embodiments of automatic compensation for electrical devices in electrical systems are shown. Automatic compensation for electrical devices in electrical systems may, however, be embodied in many different forms and should not be construed as limited to the example embodiments set forth herein. Rather, these example embodiments are provided so that this disclosure will be thorough and complete, and will fully convey the scope of automatic compensation for electrical devices in electrical systems to those of ordinary skill in the art. Like, but not necessarily the same, elements (also sometimes called components) in the various figures are denoted by like reference numerals for consistency.

Terms such as “first”, “second”, “third”, and “within” are used merely to distinguish one component (or part of a component or state of a component) from another. Such terms are not meant to denote a preference or a particular orientation, and such terms are not meant to limit embodiments of automatic compensation for electrical devices in electrical systems. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

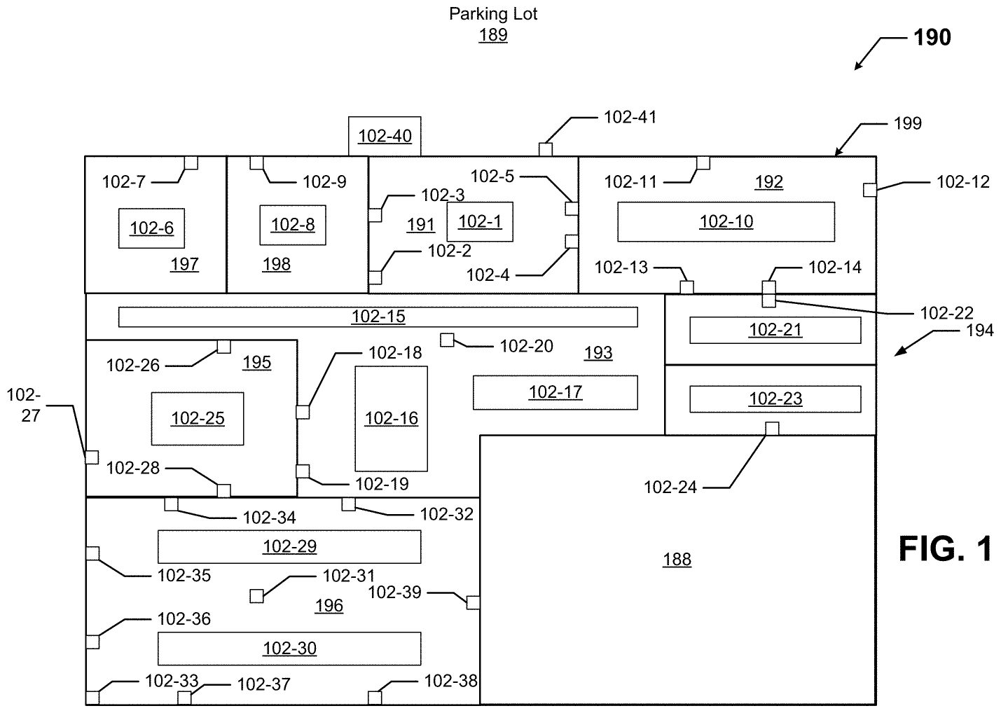

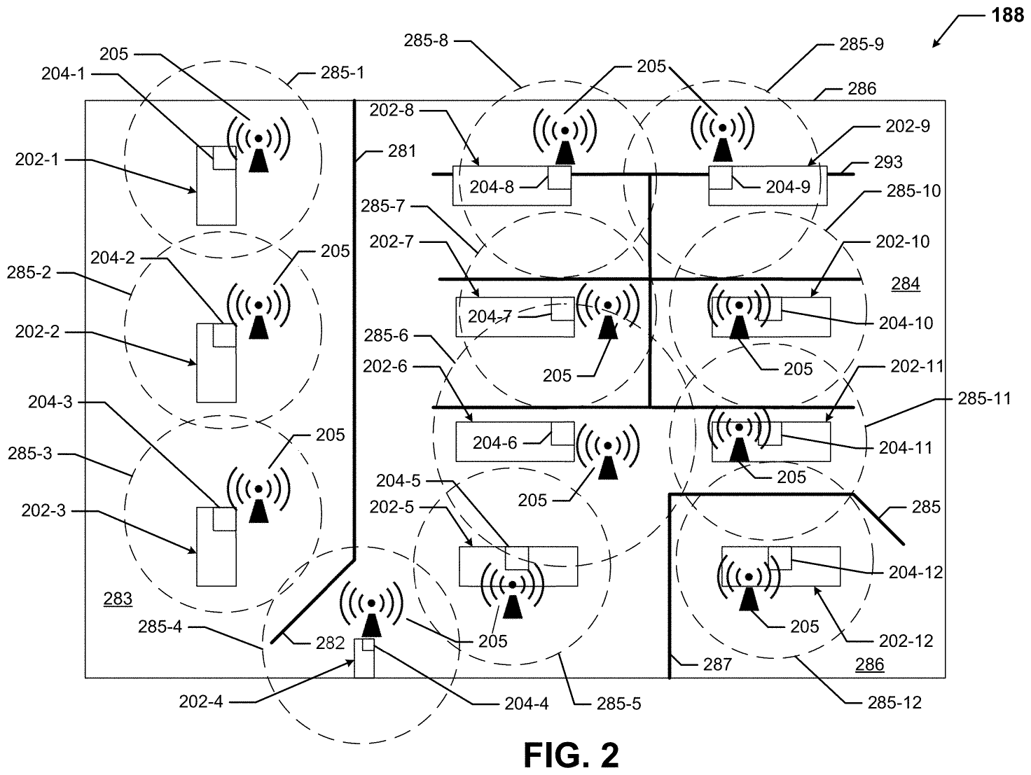

FIG. 1 shows an office space 199 (also more generally called a volume of space 199) inside a building 190 in which example embodiments can be used. FIG. 2 shows a detail of the work area 188 of the office space 199 of FIG. 1. The office space 199 includes a number of adjoining rooms. In this case, the office space 199 shown in FIG. 1 includes a reception area 191 that is adjoining to a hallway 193. The hallway 193 leads to restrooms 194, a large office 192, two smaller offices 197 and 198, a conference room 196, a break room 195, and a work area 188.

The work area 188, as shown in FIG. 2, is defined by exterior walls 286 that form the outer perimeter of the work area 188. The work area 188 is divided into a number of areas or zones. For example, a wall 281 and a door 282 separate a hallway 283 from a work space 284. As another example, wall 287 and door 285 define an office 286 within the work area 188 and separate from the work space 284. The work space 284, the hallway 283, and the office 286 are examples of zones that can be created using example embodiments. There is also a parking lot 189 that is located outside the office space 199 adjacent to the reception area 191.

Each room of the office space 199 includes one or more of a number of electrical devices 102, 202. The electrical devices 102, 202 shown in FIGS. 1 and 2 are not exclusive and are not meant to be limiting in terms of the number and/or type of electrical devices that can be found in the office space. Also, each electrical device 102, 202 of FIGS. 1 and 2 can be part of one or more of a number of electrical systems. Examples of such electrical systems can include, but are not limited to, a lighting system, a security system, an audio-visual system, an electrical outlet system, an emergency system, a fire protection system, and a HVAC system.

In this case, the reception area 191 includes an electrical device 102-1 in the form of a light fixture, an electrical device 102-2 in the form of a thermostat, two electrical devices (electrical device 102-3 and electrical device 102-4) in the form of electrical receptacles, and an electrical device 102-5 in the form of a security camera. The office 197 in this example includes an electrical device 102-6 in the form of a light fixture and an electrical device 102-7 in the form of an electrical outlet. The office 198 in this example includes an electrical device 102-8 in the form of a light fixture and an electrical device 102-9 in the form of an electrical outlet. The office 192 includes an electrical device 102-10 in the form of a light fixture, three electrical devices (electrical device 102-11, electrical device 102-12, and electrical device 102-14) in the form of electrical outlets, and an electrical device 102-13 in the form of a thermostat.

The hallway 193 in FIG. 1 includes three electrical devices (electrical device 102-15, electrical device 102-16, and electrical device 102-17) in the form of light fixtures, an electrical device 102-18 in the form of an electrical outlet, an electrical device 102-19 in the form of a thermostat, and an electrical device 102-20 in the form of a security camera. The restrooms 194 in this example include two electrical devices (electrical device 102-21 and electrical device 102-23) in the form of a light fixture and two electrical devices (electrical device 102-22 and electrical device 102-24) in the form of electrical outlets. The break room 195 in FIG. 1 includes an electrical device 102-25 in the form of a light fixture, and three electrical devices (electrical device 102-26, electrical device 102-27, and electrical device 102-28) in the form of electrical outlets.

The conference room 196 in this example includes two electrical devices (electrical device 102-29 and electrical device 102-30) in the form of light fixtures, an electrical device 102-32 in the form of a thermostat, an electrical device 102-31 in the form of a projector, an electrical device 102-33 in the form of a security camera, and six electrical devices (electrical device 102-34, electrical device 102-35, electrical device 102-36, electrical device 102-37, electrical device 102-38, and electrical device 102-39) in the form of electrical outlets. There can also be one or more electrical devices located outside the building 190. For example, as shown in FIG. 1, there can be an electrical device 102-40 in the form of a light fixture and an electrical device 102-41 in the form of a security camera located near the entrance to the reception area 191. There can also be one or more other electrical devices (e.g., pole-mounted parking lot light fixtures in the parking lot 189), not shown in FIG. 1.

As shown in FIG. 2, the hallway 283 of the work area 188 includes three electrical devices (electrical device 202-1, electrical device 202-2, and electrical device 202-3) in the form of light fixtures. The office 286 of the work space 284 of FIG. 2 includes an electrical device 202-12 in the form of a light fixture. The work space 284 of the work area 188 of FIG. 2 includes an electrical device 202-4 in the form of an illuminated exit sign and seven electrical devices (electrical device 202-5, electrical device 202-6, electrical device 202-7, electrical device 202-8, electrical device 202-9, electrical device 202-10, and electrical device 202-11) in the form of light fixtures. The work area 188 can also have any of a number of other electrical devices (e.g., electrical outlets, cameras, thermostats), but are not shown in FIG. 2 make the features in FIG. 2 easier to distinguish.

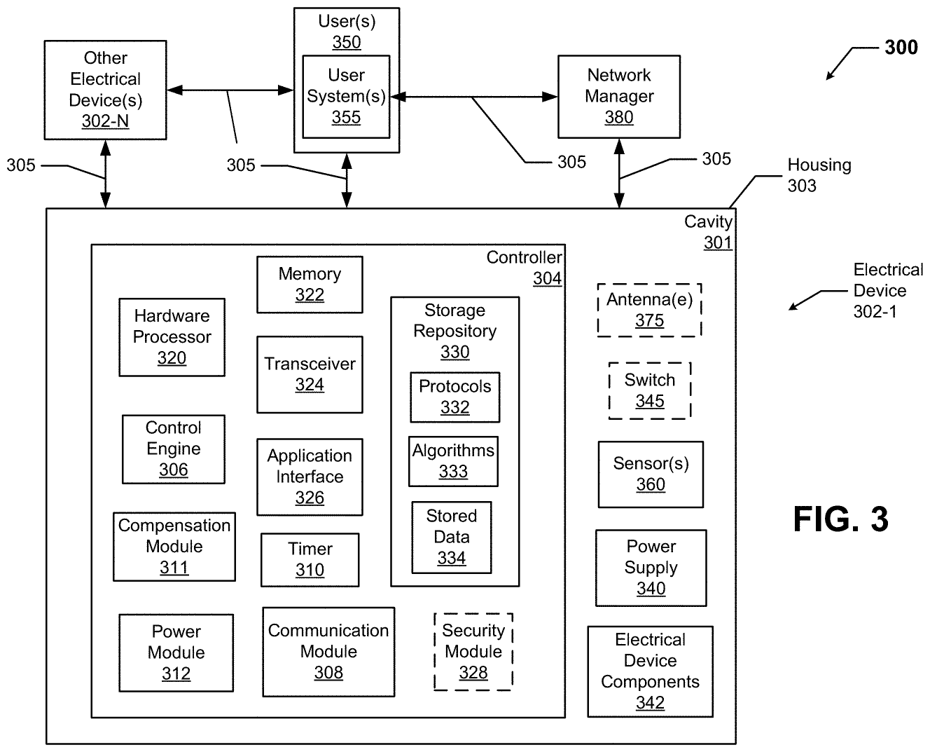

Each of the electrical devices 202-1 through 202-12 in the work area 188 of FIG. 2 can include a controller 204 (described below with respect to FIG. 3). Further, each controller 204 includes a transceiver (also described below with respect to FIG. 3), and each transceiver in this example transmits and receives signals. Similarly, one or more of the electrical devices 102 of FIG. 1 can include a controller and transceiver, allowing them to send and receive signals. These signals are transmitted using the communication links 205 (also defined below with respect to FIG. 3) by which the electrical devices 102, 202 of FIGS. 1 and 2 can communicate with each other. Each transceiver has a range 285 (e.g., 10 meters) that defines a maximum area or volume of space in which the transceiver can send and receive signals.

For example, electrical device 202-1 includes a controller 204-1, where the transceiver of the controller 204-1 has a communication range 285-1. Electrical device 202-2 includes a controller 204-2, where the transceiver of the controller 204-2 has a communication range 285-2. Electrical device 202-3 includes a controller 204-3, where the transceiver of the controller 204-3 has a communication range 285-3. Electrical device 202-4 includes a controller 204-4, where the transceiver of the controller 204-4 has a communication range 285-4. Electrical device 202-5 includes a controller 204-5, where the transceiver of the controller 204-5 has a communication range 285-5.

Electrical device 202-6 includes a controller 204-6, where the transceiver of the controller 204-6 has a communication range 285-6. Electrical device 202-7 includes a controller 204-7, where the transceiver of the controller 204-7 has a communication range 285-7. Electrical device 202-8 includes a controller 204-8, where the transceiver of the controller 204-8 has a communication range 285-8. Electrical device 202-9 includes a controller 204-9, where the transceiver of the controller 204-9 has a communication range 285-9. Electrical device 202-10 includes a controller 204-10, where the transceiver of the controller 204-10 has a communication range 285-10. Electrical device 202-11 includes a controller 204-11, where the transceiver of the controller 204-11 has a communication range 285-11. Electrical device 202-12 includes a controller 204-12, where the transceiver of the controller 204-12 has a communication range 285-12.

A transceiver of an electrical device 102, 202 can communicate directly with a transceiver of another electrical device 102, 202 if the communication range 285 of one transceiver intersects the communication range 285 of another transceiver. In this example, communication range 285-1 intersects communication range 285-2, which intersects communication range 285-3, which intersects communication range 285-4, which intersects communication range 285-5, which intersects range 285-6, which intersects range 285-7, which intersects communication range 285-8, which intersects communication range 285-9, which intersects communication range 285-10, which intersects communication range 285-11, which intersects communication range 285-12. In other words, the controllers 204 of the electrical devices 202 of FIG. 2 are communicably coupled to each other in a daisy-chain configuration. In other embodiments, the range 285 of the transceiver of one electrical device 202 can intersect with more than two communication ranges 285 of the transceivers of one or more other electrical devices 202.

Indirect communication between non-adjacent electrical devices 102, 202 can be relayed through one or more intermediate electrical devices 102, 202. These communication ranges 285 of an electrical device can be expanded or reduced to increase or decrease the number of other electrical devices that are in direct communication with a signal (e.g., signal 176) broadcast by that electrical device 102, 202. The size of a communication range 285 of one electrical device 102, 202 can be the same as, or different than, the size of the communication range 285 of one or more other electrical devices 102, 202.

In this example, if the electrical device 202-6 broadcasts a signal, only electrical device 202-5, electrical device 202-7, and electrical device 202-11 receive that signal. In this way, the electrical devices 102, 202 can use Received Signal Strength Indication (RSSI) technology. As discussed below with respect to FIG. 3, an electrical device 102, 202 can additionally or alternatively use one or more of a number of different wired and/or wireless technologies and protocols to send and receive signals.

FIG. 3 shows a system diagram of a system 300 that includes a controller 304 of an electrical device 302-1 in accordance with certain example embodiments. The system 300 can include one or more users 350, a network manager 380, the electrical device 302-1, and one or more other electrical devices 302-N. In addition to the controller 304, the electrical device 302-1 can include a power supply 340, a number of electrical device components 342, one or more optional antennae 375, one or more optional switches 345, and one or more sensors 360. The controller 304 can include one or more of a number of components. Such components, can include, but are not limited to, a control engine 306, a communication module 308, a timer 310, a compensation module 311, a power module 312, a storage repository 330, a hardware processor 320, a memory 322, a transceiver 324, an application interface 326, and, optionally, a security module 328.

The components shown in FIG. 3 are not exhaustive, and in some embodiments, one or more of the components shown in FIG. 3 may not be included in an example electrical device. Any component of the example electrical device 302-1 can be discrete or combined with one or more other components of the electrical device 302-1. The electrical device 302-1 and the other electrical devices 302-N can collectively be referred to as electrical devices 302 herein.

Referring to FIGS. 1 through 3, a user 350 may be any person that interacts with electrical devices. Examples of a user 350 can include, but are not limited to, an employee, a supervisor, a visitor, an engineer, an electrician, an instrumentation and controls technician, a mechanic, an operator, a consultant, a systems commissioner, a janitor, a vendor, a manager, a contractor, and a manufacturer's representative. The user 350 can include a user system 355, which can include a user interface (e.g., a button), an optional display (e.g., a GUI) and/or an optional controller, such as the controller 304 of the electrical device 302-1 described below. Examples of a user system 355 can include, but are not limited to, a remote control, a hand-held transmitter, a personal computer (PC), a laptop, and a mobile phone.

The user system 355 can also include software (e.g., an app, a program) that allows a user 350 to communicate with and/or adjust compensation levels for one or more aspects of one or more electrical devices 302 (or component thereof, such as a sensor 360) in the system 300. For example, the software on the user system 355 can allow a user 350 to have some or all electrical devices 302 in a volume of space (e.g., the conference room 196) that receive a signal broadcast by the user system 355 respond to an instruction that specific electrical devices 302 that are light fixtures increase lumen output by 10%. In addition, or in the alternative, such software can be included with the network manager 380. The signals sent by the user system 355 to the electrical devices 302 can be addressable, so that only the electrical devices 302 with the specified addresses respond to the signal, while the rest of the electrical devices 302 ignore the signal.

In some cases, the user system 355 of a user 350 can also interact with (e.g., sends data to, receives data from) the controller 304 of the electrical device 302-1 via the application interface 326 (described below) using communication links 305. The user system 355 of a user 350 can also interact with one or more other electrical devices 302-N and/or the network manager 380 using communication links 305.

Interaction between a user system 355 of a user 350, the electrical device 302-1, the other electrical devices 302-N, and the network manager 380 is conducted using communication links 305. Each communication link 305 can include wired (e.g., Class 1 electrical cables, Class 2 electrical cables, electrical connectors, electrical conductors, electrical traces on a circuit board, power line carrier, DALI, RS485) and/or wireless (e.g., Wi-Fi, visible light communication, cellular networking, Bluetooth, WirelessHART, ISA100) technology. For example, a communication link 305 can be (or include) one or more electrical conductors that are coupled to an optional antenna 375 of the electrical device 302-1.

A communication link 305 can transmit signals (e.g., power signals, communication signals, control signals, data) between the controller 304, a user system 355, the network manager 380, and/or the controllers of the other electrical devices 302-N. One or more communication links 305 can also transmit signals between components (e.g., power module 312, control engine 306, storage repository 330) within the controller 304.

The network manager 380 is a device or component that controls all or a portion of the system 300, which can include the controller 304 of the electrical device 302-1, the user system 355 of a user 350, the network manager 380, and the other electrical devices 302-N that are communicably coupled, directly or indirectly, to the network manager 380. The network manager 380 can be substantially similar to, or include some or all of the components of, the controller 304. Alternatively, the network manager 380 can include one or more of a number of features and functionality in addition to, or altered from, the features and functionality of the controller 304 described below. As described herein, communication with the network manager 380 can include communicating with one or more other components (e.g., another network manager of another system). In such a case, the network manager 380 can facilitate such communication. The network manager 380 can be called other names, such as master controller and network controller.

The other electrical devices 302-N are part of the system 300 with the electrical device 302-1. The other electrical devices 302-N can be substantially the same as the electrical device 302-1 described herein. The function of one of the other electrical devices 302-N can be the same as, or different than, the function of one or more of the other electrical devices 302-N and/or the electrical device 302-1. One or more components of the electrical device 302-1 can be shared with one or more of the other electrical devices 302-N. For example, the controller 304 of the electrical device 302-1 can also control some or all of the other electrical devices 302-N. As another example, measurement made by a sensor 360 of the electrical device 302-1 can be shared with one or more of the other electrical devices 302-N.

The electrical device 302-1 can include one or more sensors 360. Each sensor 360 can measure one or more parameters. The parameters measured by a sensor 360 may or may not directly affect the operation of the electrical device 302-1 and/or the other electrical devices 302-N. The parameters can include, but are not limited to, pressure, temperature, carbon monoxide, ambient light, sound, motion, carbon dioxide, smoke, current, voltage, resistance, and humidity.

Examples of types of sensors 360 can include, but are not limited to, a passive infrared sensor, a photocell, a differential pressure sensor, a humidity sensor, a pressure sensor, an air flow monitor, a gas detector, an ammeter, a voltmeter, an ohmmeter, a vibration sensor, and a resistance temperature detector. Each sensor 360 can use one or more of a number of communication protocols, for example to send measurements of a parameter and to receive instructions. A sensor 360 can be associated with the electrical device 302-1 and/or one or more other electrical devices 302-N in the system 300.

In some cases, a sensor 360 is a stand-alone device that communicates with one or more of the electrical devices 302 in the system 300. In such a case, the stand-alone sensor 360, sometimes called an integrated sensor, can include its own controller, such as the controller 304 of the electrical device 302-1. When the sensor 360 is an integrated sensor, then the sensor 360 can be considered an electrical device 302.

A sensor 360 can receive power from one or more of any of a number of sources. For example, the power supply 340 of the electrical device 302-1 can provide power to a sensor 360. As another example, a sensor 360 can include an energy storage device (e.g., a battery). As yet another example, an independent power supply (not associated with the electrical device 302-1) can provide power to a sensor 360. In some cases, as with an integrated sensor, a sensor 360 can include one or more components (e.g., transceiver) that allow the sensor 360 to communicate with one or more controllers (e.g., controller 304), a user system 355, and/or the network manager 380.

The user system 355 of a user 350, the network manager 380, the other electrical devices 302-N, and/or the sensors 360 can interact with the controller 304 of the electrical device 302-1 using the application interface 326 in accordance with one or more example embodiments. Specifically, the application interface 326 of the controller 304 receives data (e.g., information, communications, instructions, updates to firmware) from and sends data (e.g., information, communications, instructions) to the user system 355 of a user 350, the network manager 380, the other electrical devices 302-N, and/or each sensor 360. The user system 355 of a user 350, the network manager 380, the other electrical devices 302-N, and/or each sensor 360 can include an interface to receive data from and send data to the controller 304 in certain example embodiments. Examples of such an interface can include, but are not limited to, a graphical user interface, a touchscreen, an application programming interface, a keyboard, a monitor, a mouse, a web service, a data protocol adapter, some other hardware and/or software, or any suitable combination thereof.

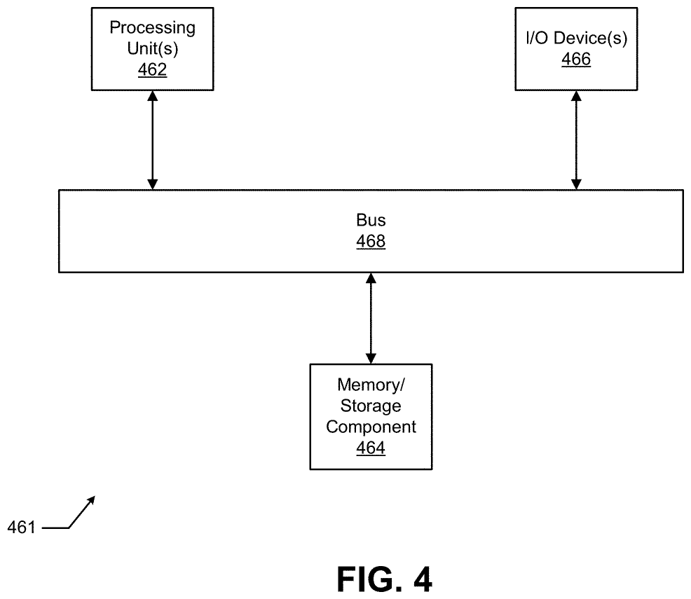

The controller 304, the user system 355 of a user 350, the network manager 380, the other electrical devices 302-N, and/or the sensors 360 can use their own system or share a system in certain example embodiments. Such a system can be, or contain a form of, an Internet-based or an intranet-based computer system that is capable of communicating with various software. A computer system includes any type of computing device and/or communication device, including but not limited to the controller 304. Examples of such a system can include, but are not limited to, a desktop computer with Local Area Network (LAN), Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 4.

Further, as discussed above, such a system can have corresponding software (e.g., user software, controller software, network manager software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wired and/or wireless segments according to some example embodiments. The software of one system can be a part of, or operate separately but in conjunction with, the software of another system within the system 300.

The electrical device 302-1 can include a housing 303. The housing 303 can include at least one wall that forms a cavity 301. In some cases, the housing 303 can be designed to comply with any applicable standards so that the electrical device 302-1 can be located in a particular environment. The housing 303 can take any form suitable for the electrical device 302-1. For example, when the electrical device 302-1 is a light fixture, the housing 303 can form any type of light fixture, including but not limited to a troffer light fixture, a down can light fixture, a recessed light fixture, and a pendant light fixture. When the electrical device 302-1 is multi-functional, the housing 303 can be configured to combine those functions. For example, the electrical device 302-1 can be a ceiling fan with a light. As another example, the electrical device 302-1 can be a garage door opener with a light.

The housing 303 of the electrical device 302-1 can be used to house one or more components of the electrical device 302-1, including one or more components of the controller 304. For example, as shown in FIG. 3, the controller 304 (which in this case includes the control engine 306, the communication module 308, the timer 310, the compensation module 311, the power module 312, the storage repository 330, the hardware processor 320, the memory 322, the transceiver 324, the application interface 326, and the optional security module 328), the power supply 340, the electrical device components 342, the optional antennae 375, the optional switches 345, and the sensors 360 are disposed in the cavity 301 formed by the housing 303. In alternative embodiments, any one or more of these or other components (e.g., an antenna 375, a sensor 360) of the electrical device 302-1 can be disposed on the housing 303 and/or remotely from the housing 303.

The storage repository 330 can be a persistent storage device (or set of devices) that stores software and data used to assist the controller 304 in communicating with the user system 355 of a user 350, the network manager 380, the other electrical devices 302-N, and one or more sensors 360 within the system 300. In one or more example embodiments, the storage repository 330 stores one or more protocols 332, one or more algorithms 333, and stored data 334. The protocols 332 can be one or more of any number of procedures (e.g., a series of method steps) and/or other similar operational procedures that the control engine 306 of the controller 304 follows based on certain conditions at a point in time.

The protocols 332 can include one or more protocols used for communication. The protocols 332 used for communication can be used to send and/or receive data between the controller 304 and the user system 355 of the user 350, the network manager 380, the sensors 360, and the other electrical devices 302-N. One or more of the protocols 332 used for communication can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the protocols 332 used for communication can provide a layer of security to the data transferred within the system 300.

An example of a protocol 332 is receiving a signal broadcast by a user system 355. In such a case, the protocol 332 can require the control engine 306 to initiate a communication with the network manager 380 about the signal received. Another example of a protocol 332 is using the control engine 306, with instructions from the network manager 380, to assign the electrical device 302-1 into a virtual zone or group in response to the signal.

Still another example of a protocol 332 is to check one or more communication links 305 with the network manager 380 and, if a communication link 305 is not functioning properly, allow the controller 304 to operate autonomously from the rest of the system 300. As another example of a protocol 332, configurations of the controller 304 can be stored in memory 322 (e.g., non-volatile memory) so that the controller 304 (or portions thereof) can operate regardless of whether the controller 304 is communicating with the network manager 380 and/or other components in the system 300. Yet another example of a protocol 332 is to have the controller 304 operate in an autonomous control mode if one or more components (e.g., the communication module 308, the transceiver 324) of the controller 304 that allows the controller 304 to communicate with another component of the system 300 fails.

The algorithms 333 can be any models, formulas, and/or other similar operational implementations that the control engine 306 of the controller 304 uses. An algorithm 333 can at times be used in conjunction with one or more protocols 332. Stored data 334 can be any historical, present, and/or forecast data. Stored data 334 can be associated with an optional antenna 175, an optional switch 145, a sensor 360, any electrical device components 342, the power supply 340, the controller 304, the network manager 380, and the user system 355 of a user 350. Such stored data 334 can include, but is not limited to, settings, threshold values, default values, user preferences, and results of an algorithm.

Examples of a storage repository 330 can include, but are not limited to, a database (or a number of databases), a file system, a hard drive, flash memory, cloud-based storage, some other form of solid state data storage, or any suitable combination thereof. The storage repository 330 can be located on multiple physical machines, each storing all or a portion of the protocols 332, the algorithms 333, and/or the stored data 334 according to some example embodiments. Each storage unit or device can be physically located in the same or in a different geographic location.

The storage repository 330 can be operatively connected to the control engine 306. In one or more example embodiments, the control engine 306 includes functionality to communicate with the user system 355 of a user 350, the network manager 380, and the other electrical devices 302-N in the system 300. More specifically, the control engine 306 sends information to and/or receives information from the storage repository 330 in order to communicate with the user system 355 of a user 350, the network manager 380, and the other electrical devices 302-N. As discussed below, the storage repository 330 can also be operatively connected to the communication module 308 in certain example embodiments.

In certain example embodiments, the control engine 306 of the controller 304 controls the operation of one or more components (e.g., the communication module 308, the timer 310, the transceiver 324) of the controller 304. For example, the control engine 306 can activate the communication module 308 when the communication module 308 is in “sleep” mode and when the communication module 308 is needed to send data received from another component (e.g., a user system 355, the network manager 380) in the system 300. As another example, the control engine 306 can operate the transceiver 324 to send a communication (e.g., notifying that a signal has been received from a user system 355) to another component (e.g., the network manager 380) in the system 300. As another example, the control engine 306 can acquire the current time using the timer 310. The timer 310 can enable the controller 304 to control the electrical device 302-1 even when the controller 304 has no communication with the network manager 380.

As another example, the control engine 306 can check one or more communication links 305 between the controller 304 and the network manager 380 and, if a communication link 305 is not functioning properly, allow the controller 304 to operate autonomously from the rest of the system 300. As yet another example, the control engine 306 can store configurations of the controller 304 (or portions thereof) in memory 322 (e.g., non-volatile memory) so that the controller 304 (or portions thereof) can operate regardless of whether the controller 304 is communicating with the network controller 380 and/or other components in the system 300.

As still another example, the control engine 306 can determine, based on a measurement by one or more sensors 360, that an electrical device 302 (or portion thereof) has failed or is failing. As a result of this failure, the control engine 306 can direct the compensation module 311 to determine how one or more of the other electrical devices 302-N (or portions thereof) can be adjusted to compensate for the failed or failing electrical device 302-1. When the control engine 306 receives the conclusions of the compensation module 311 (which can use one or more algorithms 333), the control engine 306 can make adjustments to the appropriate other electrical devices 302-N based on those conclusions. The control engine 306 can manage multiple failures of one or more electrical devices 302 in one or more electrical systems (e.g., lighting system, HVAC system, security system) at the same point in time.

The control engine 306 can also continue to monitor (e.g., continuously, periodically, randomly, based on satisfaction of some condition) measurements made by one or more of the sensors 360 to determine, in conjunction with the compensation module 311, if further adjustments of the other electrical devices 302-N need to be made due to insufficiency of the initial adjustment to compensate for the failed electrical device 302-1. The control engine 306 can also use the transceiver 324 to notify a user 350 and/or the network manager 380 as to a specific failure of an electrical device 302 in the system 300. In this way, repair of the defective electrical device 302 (or component thereof) can be scheduled and executed efficiently.

In communications sent by the control engine 306 to a user 350 and/or a network manager 380, such communications can be general notifications or include significant detail as to the status of a compensation measure taken by the control engine 306. For example, a communication by the control engine 306 can include information such as “the overall area is maintaining the desired light level, but sections P and Q are at a brighter than desired level. This can lead to acceleration of future failure of light fixtures 17 and 19 if this mode of operation is kept for an extended period of time. We recommend that the power supply for light fixture 18 be repaired within the next 3 days so that light fixtures 17 and 19 can be returned to normal operations.”

In some cases, the system 300 can be experiencing multiple failures of electrical devices 302 (or portions thereof) at one time. For example, during a violent storm, multiple light fixtures in a system can be damaged to the point where they cannot operate. In such cases, it may be possible that, after assessing all electrical devices 302 in the system 300, compensation orchestrated by the control engine 306 is not possible because the failures exceed design parameters. In such a case, the control engine 306 can communicate this situation to a user 350 and/or the network manager 380 to convey a sense of urgency to repair or replace the failed electrical devices 302 for which there is insufficient compensation available from adjacent electrical devices 302.

In certain example embodiments, the control engine 306 can compensate (or at least attempt to compensate) for multiple electrical devices 302 that have failed or are failing at the same time or over the same period of time. If the control engine 306 is unable to completely compensate for a failed or failing electrical device 302, then the control engine 306 can provide as much compensation as possible, considering such factors as, for example, public safety, impact on long-term operation of the compensating electrical devices 302, and expected duration of the failure of the failed electrical device 302.

In some cases, the control engine 306 can communicate with one or more external systems (e.g., a maintenance scheduling system, an inventory management system, a vendor system, an accounting system) to automatically order any necessary parts, schedule maintenance personnel, verify completion of the repair work, and make associated payments. The control engine 306 can further determine, based on measurements made by one or more of the sensors 360, that the failure of the electrical device 302-1 has been resolved and direct the one or more other electrical devices 302-N that were adjusted to provide compensation during the failure to return to their default operating settings. In certain example embodiments, the control engine 306 can at least assist in selecting the number, type, style, and location of each of the electrical devices 302 when designing the electrical system 300.

In some cases, rather than acting based on measurements made by a sensor 360, the control engine 306 can control one or more electrical devices 302 to compensate for a failure of another electrical device 302 in the system 300 based on some other factor. For example, the control engine 306 can receive a direct communication from a user system 355 notifying the control engine 306 that a particular electrical device 302 (or component thereof) is out of service, failed, or otherwise not working properly. Based on this information from the user system 355, without verification from a sensor 360, the control engine 306 can control one or more other electrical devices 302 in the system 300 to compensate for this failure reported by the user system 355.

Similarly, the control engine 306 can maintain this compensatory mode of operation until the control engine 306 receives a subsequent communication from a user system 355 that the previously-malfunctioning electrical device 302 is now operating properly. In response to this subsequent communication from the user system 355, the control engine 306 can return the settings of the electrical devices 302 being used by the control engine 306 for compensation to a normal operating level.

All of these actions taken by the control engine 306 can be based on one or more protocols 332 using one or more algorithms 333. In addition, the actions taken by the control engine 306 can be performed in substantially real time. For example, the amount of time from determining that an electrical device 302 is failed or is failing to controlling one or more other electrical devices 302 to compensate for that failure can take less than a second or two.

The control engine 306 of the controller 304 of the electrical device 302-1 can provide control, communication, and/or other similar signals to the user system 355 of a user 350, the network manager 380, the sensors 360, and the other electrical devices 302-N. Similarly, the control engine 306 can receive control, communication, and/or other similar signals from the user system 355 of a user 350, the network manager 380, the sensors 360, and the other electrical devices 302-N. The control engine 306 can control one of its components (e.g. the transceiver 324) automatically (for example, based on one or more protocols 332 stored in the storage repository 330) and/or based on control, communication, and/or other similar signals received from another device (e.g., the user system 355 of a user 350) through a communication link 305. The control engine 306 may include a printed circuit board, upon which the hardware processor 320 and/or one or more discrete components of the controller 304 are positioned.

In certain example embodiments, the control engine 306 can include an interface that enables the control engine 306 to communicate with one or more components (e.g., power supply 340) of the electrical device 302-1. For example, if the power supply 340 of the electrical device 302-1 operates under IEC Standard 62386, then the power supply 340 can include a digital addressable lighting interface (DALI). In such a case, the control engine 306 can also include a DALI to enable communication with the power supply 340 within the electrical device 302-1. Such an interface can operate in conjunction with, or independently of, the protocols 332 used to communicate between the controller 304 and the user system 355 of a user 350, the network manager 380, the sensors 360, and the other electrical devices 302-N.

The control engine 306 (or other components of the controller 304) can also include one or more hardware components and/or software elements to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (VC), and a pulse width modulator (PWM).

The communication module 308 of the controller 304 determines and implements the communication protocol (e.g., from the protocols 332 of the storage repository 330) that is used when the control engine 306 communicates with (e.g., sends signals to, receives signals from) the user system 355 of a user 350, the network manager 380, the sensors 360, and the other electrical devices 302-N. In some cases, the communication module 308 accesses the stored data 334 to determine which communication protocol is used to communicate with the network manager 380. In addition, the communication module 308 can interpret the protocol 332 of a communication received by the controller 304 so that the control engine 306 can interpret the communication.

The communication module 308 can send and receive data between the network manager 380, the other electrical devices 302-N, the sensors 360, and/or the user system 355 of a user 350 and the controller 304. The communication module 308 can send and/or receive data in a given format that follows a particular protocol 332. The control engine 306 can interpret the data packet received from the communication module 308 using the protocol 332 information stored in the storage repository 330. The control engine 306 can also facilitate the data transfer between the network manager 380, the other electrical devices 302-N, the sensors 360, and/or the user system 355 of a user 350 by converting the data into a format understood by the communication module 308.

The communication module 308 can send data (e.g., protocols 332, algorithms 332, stored data 334, operational information, error codes, threshold values, measurements made by a sensor 360) directly to and/or retrieve data directly from the storage repository 330. Alternatively, the control engine 306 can facilitate the transfer of data between the communication module 308 and the storage repository 330. The communication module 308 can also provide encryption to data that is sent by the controller 304 and decryption to data that is received by the controller 304. The communication module 308 can also provide one or more of a number of other services with respect to data sent from and received by the controller 304. Such services can include, but are not limited to, data packet routing information and procedures to follow in the event of data interruption.

The timer 310 of the controller 304 can track clock time, intervals of time, an amount of time, and/or any other measure of time. The timer 310 can also count the number of occurrences of an event, whether with or without respect to time. Alternatively, the control engine 306 can perform the counting function. The timer 310 is able to track multiple time measurements concurrently. The timer 310 can track time periods based on an instruction received from the control engine 306, based on an instruction received from the user system 355 of a user 350, based on an instruction programmed in the software for the controller 304, based on some other condition or from some other component, or from any combination thereof.

The timer 310 can be configured to track time when there is no power delivered to the controller 304 (e.g., the power module 312 malfunctions) using, for example, a super capacitor or a battery backup. In such a case, when there is a resumption of power delivery to the controller 304, the timer 310 can communicate any aspect of time to the controller 304. In such a case, the timer 310 can include one or more of a number of components (e.g., a super capacitor, an integrated circuit) to perform these functions.

The compensation module 311 of the controller 304 receives information from the control engine 306 and uses this information, along with one or more algorithms 333, to determine which and how one or more of the other electrical devices 302-N should be adjusted to compensate for the failed electrical device 302-1 or component thereof, as identified by the control engine 306. The information received by the compensation module 311 from the control engine 306 can include, but is not limited to, the particular failure or failures of a particular electrical device 302, measurements taken by one or more sensors 360, the location of the various electrical devices 302 in the system 300 relative to each other, the range of operating parameters of each of the electrical devices 302, the current operating parameters of each of the electrical devices 302, and the minimum threshold value that is acceptable when making adjustments to other electrical devices 302 for the purpose of compensating for a failed electrical device 302.

The compensation module 311 can operate using one or more protocols 322 and/or one or more algorithms 333. The compensation module 311 can send a request to the control engine 306 for more information if the compensation module 311 does not currently have enough information to determine how adjustments should be made for the purpose of compensation for a failed electrical device 302. When the failed electrical device 302 or component thereof is restored to normal operations, the control engine 306 can notify the compensation module 311 so that the compensation module 311 can establish and initiate resetting the default settings for the electrical devices 302.

If the components and/or operating parameters of a restored electrical device 302 are not identical to the components and/or operating parameters of the electrical device 302 before failing, then the compensation module 311 can use information (e.g., nameplate information, measurements from sensors 360) after the electrical device 302 is restored to determine if settings and operating values of any of the electrical devices 302 (including the restored electrical device 302) should be altered from their default values.

The power module 312 of the controller 304 provides power to one or more other components (e.g., timer 310, control engine 306) of the controller 304. In addition, in certain example embodiments, the power module 312 can provide power to the power supply 340, one or more of the sensors 360, one or more of the electrical device components 342, the switches 345, and/or the antennae 375 of the electrical device 302-1. The power module 312 can include one or more of a number of single or multiple discrete components (e.g., transistor, diode, resistor), and/or a microprocessor. The power module 312 may include a printed circuit board, upon which the microprocessor and/or one or more discrete components are positioned. In some cases, the power module 312 can include one or more components that allow the power module 312 to measure one or more elements of power (e.g., voltage, current) that is delivered to and/or sent from the power module 312.

The power module 312 can include one or more components (e.g., a transformer, a diode bridge, an inverter, a converter) that receives power (for example, through an electrical cable) from the power supply 340 and/or a source (e.g., AC mains) external to the electrical device 302-1. The power module 312 can use this power to generate power of a type (e.g., alternating current, direct current) and level (e.g., 12V, 24V, 120V) that can be used by the other components of the controller 304. In addition, or in the alternative, the power module 312 can be or include a source of power in itself to provide signals to the other components of the controller 304 and/or the power supply 340. For example, the power module 312 can be or include a battery or other form of energy storage device. As another example, the power module 312 can be or include a localized photovoltaic solar power system.

The hardware processor 320 of the controller 304 executes software, algorithms (e.g., algorithms 333), and firmware in accordance with one or more example embodiments. Specifically, the hardware processor 320 can execute software on the control engine 306 or any other portion of the controller 304, as well as software used by the user system 355 of a user 350, the network manager 380, and the other electrical devices 302-N. The hardware processor 320 can be an integrated circuit, a central processing unit, a multi-core processing chip, SoC, a multi-chip module including multiple multi-core processing chips, or other hardware processor in one or more example embodiments. The hardware processor 320 can known by other names, including but not limited to a computer processor, a microprocessor, and a multi-core processor.

In one or more example embodiments, the hardware processor 320 executes software instructions stored in memory 322. The memory 322 includes one or more cache memories, main memory, and/or any other suitable type of memory. The memory 322 can include volatile and/or non-volatile memory. The memory 322 is discretely located within the controller 304 relative to the hardware processor 320 according to some example embodiments. In certain configurations, the memory 322 can be integrated with the hardware processor 320.

In certain example embodiments, the controller 304 does not include a hardware processor 320. In such a case, the controller 304 can include, as an example, one or more field programmable gate arrays (FPGA), one or more insulated-gate bipolar transistors (IGBTs), and/or one or more integrated circuits (ICs). Using FPGAs, IGBTs, ICs, and/or other similar devices known in the art allows the controller 304 (or portions thereof) to be programmable and function according to certain logic rules and thresholds without the use of a hardware processor. Alternatively, FPGAs, IGBTs, ICs, and/or similar devices can be used in conjunction with one or more hardware processors 320.

The transceiver 324 of the controller 304 can send and/or receive control and/or communication signals. Specifically, the transceiver 324 can be used to transfer data between the controller 304 and the user system 355 of a user 350, the network manager 380, the sensors 360, and the other electrical devices 302-N. The transceiver 324 can use wired and/or wireless technology. The transceiver 324 can be configured in such a way that the control and/or communication signals sent and/or received by the transceiver 324 can be received and/or sent by another transceiver that is part of the user system 355 of a user 350, the network manager 380, the sensors 360, and the other electrical devices 302-N. The transceiver 324 can use any of a number of signal types, including but not limited to radio frequency signals and visible light signals.

When the transceiver 324 uses wireless technology, any type of wireless technology can be used by the transceiver 324 in sending and receiving signals. Such wireless technology can include, but is not limited to, Wi-Fi, Zigbee, visible light communication, cellular networking, Bluetooth Low Energy (BLE), and Bluetooth. The transceiver 324 can use one or more of any number of suitable protocols 332 for communication (e.g., ISA100, HART) when sending and/or receiving signals. Such communication protocols can be stored in the protocols 332 of the storage repository 330. Further, any transceiver information for the user system 355 of a user 350, the network manager 380, the sensors 360, and/or the other electrical devices 302-N can be part of the protocols 332 (or other areas) of the storage repository 330.

Optionally, in one or more example embodiments, the security module 328 secures interactions between the controller 304, the user system 355 of a user 350, the network manager 380, the sensors 360, and/or the other electrical devices 302-N. More specifically, the security module 328 authenticates communication from software based on security keys verifying the identity of the source of the communication. For example, user software may be associated with a security key enabling the software of the user system 355 of a user 350 to interact with the controller 304. Further, the security module 328 can restrict receipt of information, requests for information, and/or access to information in some example embodiments.

As mentioned above, aside from the controller 304 and its components, the electrical device 302-1 can include one or more optional antennae 375, one or more optional switches 345, a power supply 340, one or more sensors 360, and one or more electrical device components 342. The sensors 360 are discussed above. The electrical device components 342 of the electrical device 302-1 are devices and/or components typically found in an electrical device 302-1 to allow electrical device 302-1 to operate. An electrical device component 342 can be electrical, mechanical, electronic, or any combination thereof. For example, if the electrical device 302-1 is a light fixture, then examples of electrical device components 342 can include, but are not limited to, a light source, a heat sink, a terminal block, a wire, a lens, a reflector, a bezel, an air moving device, a baffle, a circuit board, and an energy storage device.

The power supply 340 of the electrical device 302-1 receives power (e.g., primary power, secondary power) from an external source (e.g., AC mains, a wall outlet, an energy storage device). The power supply 340 uses the power it receives to generate and provide power to the power module 312 of the controller 304, the antennae 175, the switches 145, and one or more of the electrical device components 342. The power supply 340 can be called by any of a number of other names, depending on the electrical device 302-1. For example, if the electrical device 302-1 is a light fixture, then the power supply 340 can be called, for example, a driver, a LED driver, and a ballast. The power supply 340 can include one or more of a number of single or multiple discrete components (e.g., transistor, diode, resistor), and/or a microprocessor. The power supply 340 may include a printed circuit board, upon which the microprocessor and/or one or more discrete components are positioned, and/or a dimmer.

In some cases, the power supply 340 can include one or more components (e.g., a transformer, a diode bridge, an inverter, a converter) that receives power (for example, through an electrical cable) from the power module 312 of the controller 304. Regardless of where the power supply 340 receives power, the power supply 340 generates power of a type (e.g., alternating current, direct current) and level (e.g., 12V, 24V, 120V) that can be used by sensors 360, the power module 312, the switch 345, the antennae 375, and/or the electrical device components 342. In addition, or in the alternative, the power supply 340 can be or include a source of power in itself. For example, the power supply 340 can be or include be a battery, a localized photovoltaic solar power system, or some other source of independent power.

Each optional antenna 375 of the electrical device 302-1 is a component that converts electrical power to signals (for transmitting) and signals to electrical power (for receiving). In transmission, a radio transmitter (e.g., transceiver 324) supplies, through the optional switch 345 when the switch 345 exists, an electric current oscillating at radio frequency (i.e. a high frequency alternating current (AC)) to the terminals of the antenna 375, and the antenna radiates the energy from the current as signals. In reception, an antenna 375 intercepts some of the power of signals in order to produce a tiny voltage at its terminals, which is applied through the switch 345 to a receiver (e.g., transceiver 324) to be amplified.

An optional antenna 375 can typically consist of an arrangement of electrical conductors that are electrically connected to each other (often through a transmission line) to create a body of the antenna 375. The body of the antenna 375 is electrically coupled to the transceiver 324. An oscillating current of electrons forced through the body of an antenna 375 by the transceiver 324 will create an oscillating magnetic field around the body, while the charge of the electrons also creates an oscillating electric field along the body of the antenna 375. These time-varying fields radiate away from the antenna 375 into space as a moving transverse signal (e.g., an electromagnetic field wave). Conversely, during reception, the oscillating electric and magnetic fields of an incoming signal create oscillating currents in the antenna 375.

In certain example embodiments, an antenna 375 can be disposed at, within, or on any portion of the electrical device 302-1. For example, an antenna 375 can be disposed on the housing 303 of the electrical device 302-1 and extend away from the housing 303 of the electrical device 302-1. As another example, an antenna 375 can be insert molded into a lens (a type of electrical device component 342) of the electrical device 302-1. As another example, an antenna 375 can be two-shot injection molded into the housing 303 of the electrical device 302-1. As yet another example, an antenna 375 can be adhesive mounted onto the housing 303 of the electrical device 302-1. As still another example, an antenna 375 can be pad printed onto a circuit board within the cavity 301 formed by the housing 303 of the electrical device 302-1. As yet another example, an antenna 375 can be a chip ceramic antenna that is surface mounted. As still another example, an antenna 375 can be a wire antenna.

An optional antenna 375 can be electrically coupled to the optional switch 345, which in turn is electrically coupled to the transceiver 324. Without the switch 345, an antenna 375 is directly electrically coupled to the transceiver 324. The optional switch 345 can be a single switch device or a number of switch devices arranged in series and/or in parallel with each other. The switch 345 determines which antenna 375 (in the case of multiple antennae 375) or when the lone antenna 375 is coupled to the transceiver 324 at any particular point in time.

A switch 345 can have one or more contacts, where each contact has an open state and a closed state (position). In the open state, a contact of the switch 345 creates an open circuit, which prevents the transceiver 324 from delivering a signal to or receiving a signal from the antenna 375 electrically coupled to that contact of the switch 345. In the closed state, a contact of the switch 345 creates a closed circuit, which allows the transceiver 324 to deliver a signal to or receive a signal from the antenna 375 electrically coupled to that contact of the switch 345.

In certain example embodiments, the position of each contact of the optional switch 345 is controlled by the control engine 306 of the controller 304. If the switch 345 is a single device, the switch 345 can have a single contact or multiple contacts. In any case, only one contact of the switch 345 can be active (closed) at any point in time in certain example embodiments. Consequently, when one contact of the switch 345 is closed, all other contacts of the switch 345 are open in such example embodiments.

As stated above, the electrical device 302-1 can be placed in any of a number of environments. In such a case, the housing 303 of the electrical device 302-1 can be configured to comply with applicable standards for any of a number of environments. For example, the electrical device 302-1 can be rated as a Division 1 or a Division 2 enclosure under NEC standards. Similarly, any of the devices (e.g., antenna 375) communicably coupled to the electrical device 302-1 can be configured to comply with applicable standards for any of a number of environments.

FIG. 4 illustrates one embodiment of a computing device 461 that implements one or more of the various techniques described herein, and which is representative, in whole or in part, of the elements described herein pursuant to certain exemplary embodiments. For example, the controller 304 of FIG. 3 (including components thereof, such as the control engine 306, the hardware processor 320, the storage repository 330, and the transceiver 324) can be considered a computing device 461. Computing device 461 is one example of a computing device and is not intended to suggest any limitation as to scope of use or functionality of the computing device and/or its possible architectures. Neither should computing device 461 be interpreted as having any dependency or requirement relating to any one or combination of components illustrated in the example computing device 461.

Computing device 461 includes one or more processors or processing units 462, one or more memory/storage components 464, one or more input/output (I/O) devices 466, and a bus 468 that allows the various components and devices to communicate with one another. Bus 468 represents one or more of any of several types of bus structures, including a memory bus or memory controller, a peripheral bus, an accelerated graphics port, and a processor or local bus using any of a variety of bus architectures. Bus 468 includes wired and/or wireless buses.

Memory/storage component 464 represents one or more computer storage media. Memory/storage component 464 includes volatile media (such as random access memory (RAM)) and/or nonvolatile media (such as read only memory (ROM), flash memory, optical disks, magnetic disks, and so forth). Memory/storage component 464 includes fixed media (e.g., RAM, ROM, a fixed hard drive, etc.) as well as removable media (e.g., a Flash memory drive, a removable hard drive, an optical disk, and so forth).

One or more I/O devices 466 allow a customer, utility, or other user to enter commands and information to computing device 461, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 461 is connected to a network (not shown) (e.g., a local area network (LAN), a wide area network (WAN) such as the Internet, cloud, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer system 461 includes at least the minimal processing, input, and/or output means necessary to practice one or more embodiments.

Further, those skilled in the art will appreciate that one or more elements of the aforementioned computer device 461 is located at a remote location and connected to the other elements over a network in certain exemplary embodiments. Further, one or more embodiments is implemented on a distributed system having one or more nodes, where each portion of the implementation (e.g., control engine 306) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

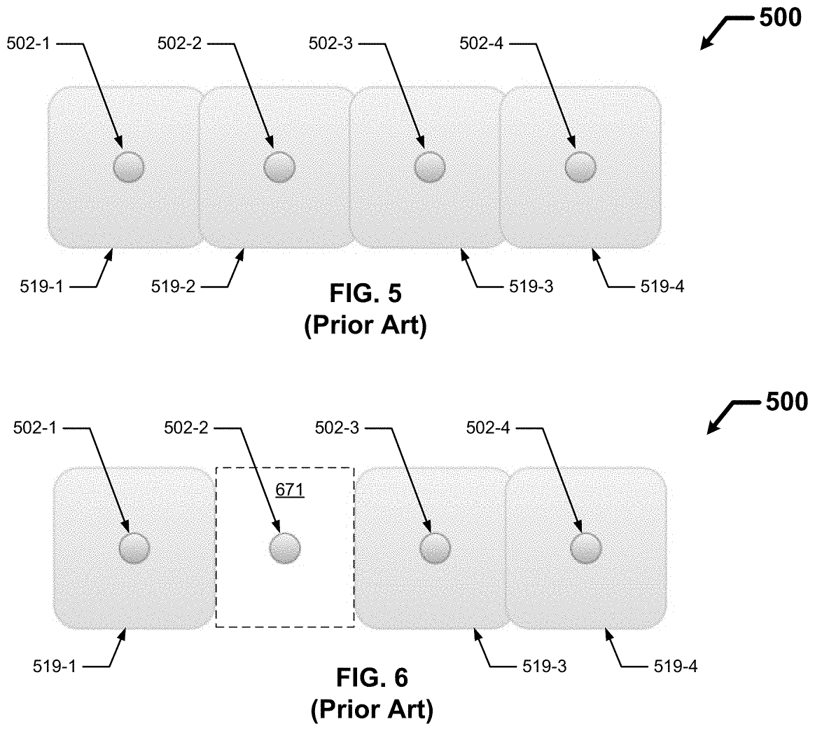

FIG. 5 shows an electrical system 500 in the current art with a number of electrical devices 502 that are all operating properly. Referring to FIGS. 1 through 5, there are four electrical devices 502 that are all light fixtures and that are oriented in a single line relative to each other. Specifically, electrical device 502-1 is adjacent to electrical device 502-2, which is adjacent to electrical device 502-3, which is adjacent to electrical device 502-4.

Since the electrical devices 502 are light fixtures, when they are operating properly, as in FIG. 5, each electrical device 502 has a range of light output 519. Specifically, electrical device 502-1 has a range of light output 519-1. Electrical device 502-2 has a range of light output 519-2. Electrical device 502-3 has a range of light output 519-3. Electrical device 502-4 has a range of light output 519-4. The ranges of light output 519 of adjacent electrical devices 502 have a slight overlap to provide continuous light coverage. Specifically, in this case, light output 519-1 and light output 519-2 overlap each other, light output 519-2 and light output 519-3 overlap each other, and light output 519-3 and light output 519-4 overlap each other.

FIG. 6 shows the electrical system 500 of FIG. 5 where electrical device 502-2 has failed. Referring to FIGS. 1 through 6, as a result of the failure of electrical device 502-2, the range of light output 519-2 for electrical device 502-2 is zero. Consequently, while the range of light output 519-3 of electrical device 502-3 and the range of light output 519-4 of electrical device 502-4 continue to overlap, as they did in FIG. 5, there is no continuity in the overall range of light output 519 in the system 500 of FIG. 5. Specifically, there is a gap 671 in the overall range of light output 519 between the range of light output 519-3 of electrical device 502-3 and the range of light output 519-1 of electrical device 502-1. In the current art, the gap 671 remains without illumination (or very limited illumination) until electrical device 502-2 is fixed and returns to normal operation.

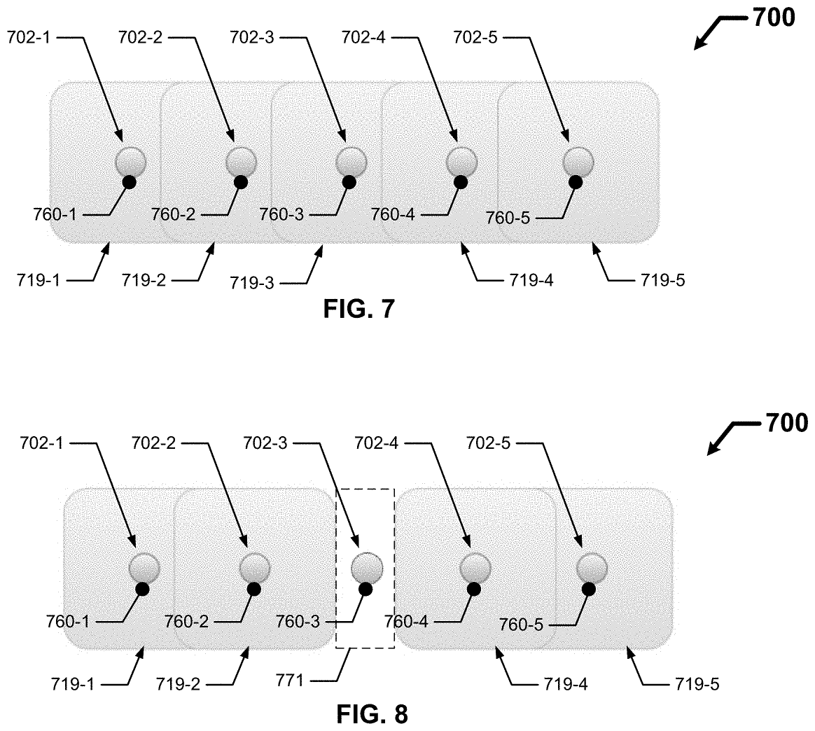

FIG. 7 shows an electrical system 700 with a number of electrical devices 702 that are all operating properly in accordance with certain example embodiments. Referring to FIGS. 1 through 7, there are five electrical devices 702 that are all light fixtures and that are oriented in a single line relative to each other. Specifically, electrical device 702-1 is adjacent to electrical device 702-2, which is adjacent to electrical device 702-3, which is adjacent to electrical device 702-4, which is adjacent to electrical device 702-5.

Since the electrical devices 702 are light fixtures, when they are operating properly, as in FIG. 7, each electrical device 702 has a range of light output 719. Specifically, electrical device 702-1 has a range of light output 719-1. Electrical device 702-2 has a range of light output 719-2. Electrical device 702-3 has a range of light output 719-3. Electrical device 702-4 has a range of light output 719-4. Electrical device 702-5 has a range of light output 719-5. The ranges of light output 719 of adjacent electrical devices 702 have a slight overlap to provide continuous light coverage.

Specifically, in this case, light output 719-1 and light output 719-2 overlap each other, light output 719-2 and light output 719-3 overlap each other, light output 719-3 and light output 719-4 overlap each other, and light output 719-4 and light output 719-5 overlap each other. Also, in this example, each electrical device 702 includes a sensor 760. Specifically, electrical device 702-1 includes sensor 760-1. Electrical device 702-2 includes sensor 760-2. Electrical device 702-3 includes sensor 760-3. Electrical device 702-4 includes sensor 760-4. Electrical device 702-5 includes sensor 760-5. Each of the sensors 760 in this case are light sensors that detect the amount of light emitted by its respective electrical device 702.

The electrical system 700 can be designed in such a way as to effectively utilize example embodiments described herein. For example, the electrical devices 702 are specifically chosen and located (arranged) in such a way that occasional compensation using example embodiments can be accomplished when a portion of an electrical device 702 in the system 700 fails. Design considerations can include, but are not limited to, light spread (range of light output 719), height from the ground, height from a ceiling, dimming capability, range of communication, and type of optical device.

This design of the electrical devices 702 within the electrical system 700 allows for a practical redundancy, so that one or more electrical devices 702 can be adjusted to compensate for the failure of another electrical device 702 in the electrical system 700. Such a design is referred to as a practical redundancy because there is not a one-for-one replacement in the event of a failure of an electrical device 702. In this particular case, part of the design of the electrical devices 702 can be that each electrical device 702, during normal operating conditions (e.g., when all electrical devices 702 in the system 700 are operating properly), have a range of light output 719 that is around 75% of full capability. Also, the overlap between the range of light output 719 for adjacent electrical devices 702 in this case is slightly greater than it is for the system 500 of FIG. 5.

FIG. 8 shows the electrical system 700 of FIG. 7 where electrical device 702-3 has failed. Referring to FIGS. 1 through 8, as a result of the failure of electrical device 702-3, the range of light output 719-3 for electrical device 702-3 is zero. Consequently, while the range of light output 719-4 of electrical device 702-4 and the range of light output 719-5 of electrical device 702-5 continue to overlap, as they did in FIG. 7, and while the range of light output 719-1 of electrical device 702-1 and the range of light output 719-2 of electrical device 702-2 continue to overlap, as they did in FIG. 7, there is no continuity in the overall range of light output 719 in the system 700 of FIG. 7. Specifically, there is a gap 771 in the overall range of light output 719 between the range of light output 719-2 of electrical device 702-2 and the range of light output 719-4 of electrical device 702-4.

In this example, the sensor 760 of each electrical device 702 can measure one or more parameters. For example, as discussed above, the parameter measured by the sensor 760 of each electrical device 702 can be light output. As another example, the parameter measured by the sensor 760 of each electrical device 702 can be power delivered to the power supply (e.g., power supply 340) of the electrical device 702. Regardless of whether the sensors 760 measure light output or power, sensor 760-3 will measure a number that is much lower than an acceptable or normal operating value (also called a range of acceptable values) for electrical device 702-3, indicating that electrical device 702-3 has failed.

If sensor 760-3 measures both power and light output, more information can be used to determine precisely what aspect of the electrical device 702-3 has failed. For example, if the amount of power measured by sensor 760-3 is in a normal range of values, but the amount of light measured by sensor 760-3 is below a normal operating value (e.g., 50% of full capacity), then the controller (e.g., controller 304) of the electrical device 702-3 can determine that only the light source of the electrical device 702-3 has failed (as opposed to the entire electrical device 702-3). As another example, if the amount of power measured by sensor 760-3 is zero, which falls below a range of acceptable values (e.g., 100 VAC to 130 VAC), then the controller of the electrical device 702-3 can determine that there is a problem with an electrical cable feeding the electrical device 702-3, a failure of the power supply (e.g., power supply 340) of the electrical device 702-3, or some other problem related to power for the electrical device 702-3. In any case, the partial or whole failure of electrical device 702-3 is determined, at least in part, using the one or more parameters measured by sensor 760-3.

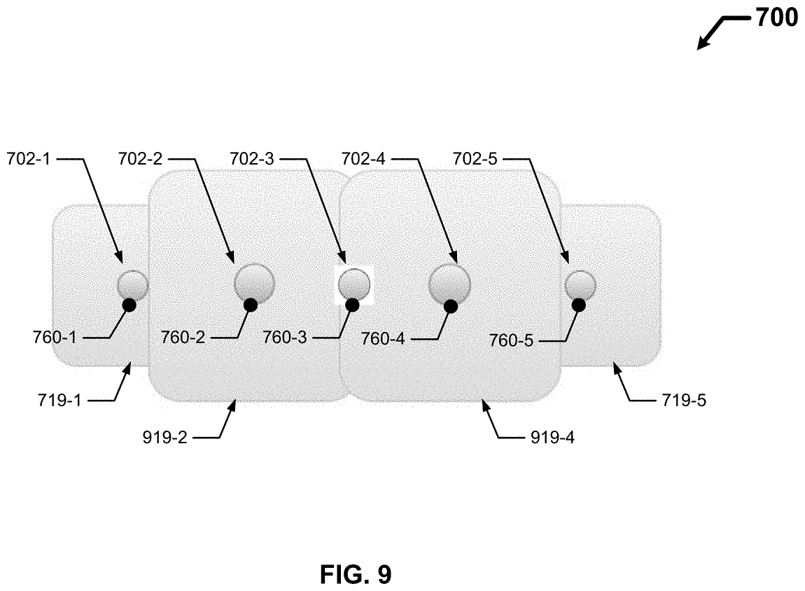

FIG. 9 shows the electrical system 700 of FIG. 8 where electrical device 702-2 and electrical device 702-4 are adjusted, using example embodimnets, to compensate for the failed electrical device 702-3. Specifically, referring to FIGS. 1 through 9, in certain example embodiments, when one or more of the sensors 760 (e.g., sensor 760-2, sensor 760-3, sensor 760-4) take measurements of a parameter that fall outside of range of acceptable, normal, or otherwise operating values, then a controller (e.g., controller 304) can arrange for one or more electrical devices 702 to adjust some aspect of their operations to compensate for the failed electrical device 702-3 (or portion thereof). The example controller can be part of one or more of the electrical devices 702, including the failed electrical device 702-3. In addition, or in the alternative, the example controller can be part of a network manager (e.g., network manager 380).

In any case, the controller can receive a measurement of one or more parameters (e.g., power, light, sound) from one or more of the sensors 760, where the measurements are associated, directly or indirectly, with the failed electrical device 702-3. The controller can then determine, based on the measurements, that the one or more parameters fall outside a range of acceptable values for electrical device 702-3, which results in a determination that electrical device 702-3 (or a component thereof, such as its light source) has failed or is failing. The controller can then determine how adjusting at least one other electrical device 702 (in this case, increasing the range of light output 719-2 of electrical device 702-2 and the range of light output 719-4 of electrical device 702-4) can compensate for the failure of electrical device 702-3. In some cases, depending on the parameter being measured by the sensors 760, adjusting electrical device 702-2 and electrical device 702-4 brings one or more of the parameters back within the range of acceptable values.

In this example, the power delivered (e.g., by the power supply 340) to the light sources of electrical device 702-2 and electrical device 702-4 is increased by the controller, thereby expanding the range of light output 719-2 (e.g., from 75% to 100%) of electrical device 702-2 and the range of light output 719-4 (e.g., from 75% to 100%) of electrical device 702-4. As a result, the range of light output 719-2 of electrical device 702-2 and the range of light output 719-4 of electrical device 702-4 now overlap each other, compensating for the loss of the light output of electrical device 702-3 and eliminating the gap 771 from FIG. 8.

Similarly, example embodiments can be used to adjust one or more electrical devices 702 when the issue causing a failure within the system 700 is fixed. In this example, if the problem (e.g., failed light source, failed power supply) of electrical device 702-3 is fixed (e.g., replace light source, replace wiring, replace power supply), then the controller receives measurements from the sensors 760 that one or more of the measured parameters now exceed a normal range of values. In such a case, the controller can again adjust electrical device 702-2 and electrical device 702-4 by returning them to their default operating values or otherwise reduce their range of light output 719. As a result, all of the parameters measured by the sensors 760 should fall back within a normal range of values.

The system 700 of FIGS. 7 through 9 can be any of a number of other electrical systems aside from a lighting system. For example, if the electrical devices 702 are microphones, and if the sensors 760 detect power or audio input, then the system can be an audio-video system. As another example, if the electrical devices 702 are cameras, and if the sensors 760 detect power or images, then the system can be a security system.

Example embodiments can automatically adjust one or more electrical devices in a system to compensate for the failure of another electrical device (or component thereof) within the system. In this way, example embodiments create a practical redundancy within one or more electrical systems using existing equipment and/or without the cost of installing additional electrical devices that would otherwise normally be used for a system without such redundancy. Example embodiments can save on maintenance and energy costs while also improving safety. Example embodiments can also be used to diagnose a problem with an electrical device in real time and automatically compensate for the full or partial loss of the electrical device in real time. Example embodiments can also report an actual or prospective failure of an electrical device (or portion thereof) and automatically schedule the repair or replacement of the electrical device. Finally, example embodiments can recognize when a failed electrical device is back in service and automatically return adjacent electrical devices to their normal operating conditions when there is no further need for compensation for the failed electrical device.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A system comprising:
a plurality of electrical devices that form an electrical system, wherein the plurality of electrical devices perform a first function;
at least one sensor that measures a first parameter; and
a controller communicably coupled to the plurality of electrical devices and the at least one sensor, wherein the controller:
receives a first measurement of the first parameter from the at least one sensor, wherein the first measurement is associated with a first electrical device of the plurality of electrical devices;
determines, based on the first measurement, that the first parameter falls outside a first range of acceptable values for the first electrical device, wherein the first parameter falling outside the first range of acceptable values is caused by a failure of the first electrical device;
determines that adjusting at least one other electrical device of the plurality of electrical devices compensates for the failure of the first electrical device; and
adjusts the at least one other electrical device of the plurality of electrical devices from a default setting to a compensatory setting to compensate for the failure of the first electrical device.

2. The system of claim 1, wherein the controller further:
receives a second measurement of the first parameter from the at least one sensor at a subsequent time, wherein the second measurement is associated with the first electrical device of the plurality of electrical devices;
determines, based on the second measurement, that the first parameter falls outside the first range of acceptable values for the first electrical device, wherein the first parameter falling outside the first range of acceptable values is caused by a repair of the first electrical device; and
adjusts the at least one other electrical device and the first electrical device to the default setting from the compensatory setting.

3. The system of claim 1, wherein the plurality of electrical devices are light fixtures.

4. The system of claim 3, wherein the first parameter is an amount of light output.

5. The system of claim 3, wherein the first parameter is power delivered to a power source of the first electrical device.

6. The system of claim 1, wherein the default setting is less than 100% of full capability, and wherein the compensatory setting is greater than the default setting.

7. The system of claim 1, wherein adjusting the at least one other electrical device of the plurality of electrical devices to the compensatory setting brings the first parameter measured by the at least one sensor within the first range of acceptable values.

8. The system of claim 1, wherein the at least one other electrical device is adjacent to the first electrical device.

9. The system of claim 1, wherein the controller further:
receives a second measurement of a second parameter from the at least one sensor, wherein the second measurement is associated with the first electrical device of the plurality of electrical devices; and
identifies, based on the second measurement of the second parameter and the first measurement of the first parameter, a specific cause for the failure of the first electrical device.

10. The system of claim 1, wherein the controller is part of the first electrical device.

11. The system of claim 1, wherein the controller is part of the at least one other electrical device.

12. The system of claim 1, wherein the controller is part of a network manager communicably coupled to the plurality of electrical devices.

13. A controller for a plurality of electrical devices, the controller comprising:
a memory for storing a plurality of instructions;
a hardware processor for executing the plurality of instructions; and
a control engine communicably coupled to the hardware processor, wherein the control engine is configured to:
receive a first measurement of a first parameter from at least one sensor, wherein the first measurement is associated with a first electrical device of the plurality of electrical devices;
determine, based on the first measurement, that the first parameter falls outside a first range of acceptable values for the first electrical device, wherein the first parameter falling outside the first range of acceptable values is caused by a failure of the first electrical device;
determine that adjusting at least one other electrical device of the plurality of electrical devices compensates for the failure of the first electrical device; and
adjust the at least one other electrical device of the plurality of electrical devices from a default setting to a compensatory setting to compensate for the failure of the first electrical device.

14. The controller of claim 13, wherein the control engine is further configured to:
receive a second measurement of the first parameter from the at least one sensor at a subsequent time, wherein the second measurement is associated with the first electrical device of the plurality of electrical devices;
determine, based on the second measurement, that the first parameter falls outside the first range of acceptable values for the first electrical device, wherein the first parameter falling outside the first range of acceptable values is caused by a repair of the first electrical device; and
adjust the at least one other electrical device and the first electrical device to the default setting from the compensatory setting.

15. The controller of claim 13, wherein the control engine is further configured to:
receive a second measurement of a second parameter from the at least one sensor, wherein the second measurement is associated with the first electrical device of the plurality of electrical devices; and
identify, based on the second measurement of the second parameter and the first measurement of the first parameter, a specific cause for the failure of the first electrical device.

16. The controller of claim 15, wherein the control engine is further configured to:
schedule maintenance to fix the specific cause for the failure of the first electrical device; and
pay for the maintenance after the maintenance has been performed.

17. A non-transitory computer readable medium comprising computer readable program code embodied therein for performing a method of compensating for a failure of a first electrical device of a plurality of electrical devices, the method comprising:
receiving, by a controller, a first measurement of a first parameter from at least one sensor, wherein the first measurement is associated with the first electrical device of the plurality of electrical devices;
determining, by the controller and based on the first measurement, that the first parameter falls outside a first range of acceptable values for the first electrical device, wherein the first parameter falling outside the first range of acceptable values is caused by a failure of the first electrical device;
determining, by the controller, that adjusting at least one other electrical device of the plurality of electrical devices compensates for the failure of the first electrical device; and
adjusting, by the controller, the at least one other electrical device of the plurality of electrical devices from a default setting to a compensatory setting to compensate for the failure of the first electrical device.

18. The non-transitory computer readable medium of claim 17, wherein the method further comprises:
receiving a second measurement of the first parameter from the at least one sensor at a subsequent time, wherein the second measurement is associated with the first electrical device of the plurality of electrical devices;
determining, based on the second measurement, that the first parameter falls outside the first range of acceptable values for the first electrical device, wherein the first parameter falling outside the first range of acceptable values is caused by a repair of the first electrical device; and
adjusting the at least one other electrical device and the first electrical device to the default setting from the compensatory setting.

19. The non-transitory computer readable medium of claim 17, wherein the method further comprises:
receiving a second measurement of a second parameter from the at least one sensor, wherein the second measurement is associated with the first electrical device of the plurality of electrical devices; and
identifying, based on the second measurement of the second parameter and the first measurement of the first parameter, a specific cause for the failure of the first electrical device.

20. The non-transitory computer readable medium of claim 19, wherein the method further comprises:
scheduling maintenance to fix the specific cause for the failure of the first electrical device; and
paying for the maintenance after the maintenance has been performed.
